(19) United States
(12) Patent Application Publication
(10) Pub. No.: US 2008/0197700 A1
(43) Pub. Date: Aug. 21, 2008

(54) Method For the Attachment of Ribbon Cable Systems

(75) Inventors: Ulrich Hartmann, Donaueschingen (DE); Rudolf Johann, Neukirchen (DE); Gunther Trogisch, Seeheim-Jugenheim (DE); Sibyll Konig, Weichering (DE)

Correspondence Address: HENRY M FEIEREISEN, LLC;HENRY M FEIEREISEN, 708 THIRD AVENUE, SUITE 1501, NEW YORK, NY, 10017, US

(73) Assignees: Peguform GmbH, Botzingen (DE); Carl Freudenberg KG, Weinheim (DE); Conti Termic microelectronic GmbH, Numberg (DE)

(21) Appl. No.: 10/595,768

(22) PCT Filed: Nov. 2, 2004
(86) PCT No.: PCT/EP04/12373

§ 371 Date: Jan. 14, 2008

(30) Foreign Application Priority Data
Nov. 11, 2003 (DE) 103 52 920.9

(51) Int. Cl. B60R 16/02

(52) U.S. Cl. 307/10.1

(57) ABSTRACT

The invention refers to a method for mounting subassemblies (17) on structural components, in particular vehicle doors (1). After preassembly of the elements of the subassembly (17) on a support element (13), the entire electric or electronic circuit that is contained in the subassembly is attached in one step to the structural component (1) The almost exclusive use of flexible printed circuit boards for the connection between the individual elements (14), such as switching, operating or signaling element and the resulting weight savings, in addition to the automation of the installation permit a significant reduction in costs for the mass production of medium or large quantities.

The invention refers to the installation of electrical switching circuits on structural components and in particular to a method for installing switching circuits on vehicle doors, whereby after preassembly onto a support element, the entire circuit can be attached to the structural component in a single step. Exclusive utilization of flexible printed circuit boards for connecting single elements, such as switching, operating or signaling elements has the advantage not only of being of less weight but also of greater efficiency relative to the serial automated assembly for medium to large scale manufacturing.

German patent application DE 100 31 487 A1 refers to a circuit assembly structure for various electronic finishing equipment for a vehicle door having a standardized circuit unit, which includes a first connector element for connection to another circuit having an electric circuit switch element. This patent application is limited to the networking of window raising switches, door lighting and similar into a single switching element, which serves as a circuit connecting structure. The basic advantage of this arrangement is the possibility that an optional circuit unit, such as a control for an electric seat positioning mechanism, can be retrofitted, since a door control unit or a standard circuit unit is provided in addition to the circuit connector structure.

DE 100 37 263 A1 discloses circuit arrangements provided for installation at the door paneling or also for installation at the door's metal side. Further described is, among others, the connection of switches with flexible printed circuits boards. Since plug connectors were predominantly used, time consuming assembly is required, in particular, when standard circuits are provided for window raising mechanisms, interior lighting and similar, which are supplemented by optional circuits for seat positioning mechanisms, unlocking the gas tank cover or trunk. The assembly lay-out is designed such that the control devices are mounted first and then each switch is connected to the conductors.

It is thus an object of the present invention to provide an improved assembly lay-out and to replace the more time consuming assembly concepts with a complete cable lay-out of the switches including the control devices.

A solution to this object is realized in accordance with the following assembly steps:

A method for connecting multiple switches, operating element, signaling elements or similar that are operated by electric energy, with a control unit mounted by an automated process onto a structural component, in particular, a vehicle door, wherein conductors, in particular in the form of flexible printed circuit boards, are utilized for transmitting the electrical energy. Such flexible conductors comprise a multitude of signaling lines arranged substantially on a flat ribbon, on which several conductors are mounted independently of each other and wherein the conductors' first end portions can each branch out into a single element, such as a switch, an operating element, signaling elements or similar and wherein the other end portions of the conductors are connected to a control unit.

The following method steps are carried out during assembly: preparing a support element for receiving all single elements, that is, the switch, operating elements, signaling elements and similar, as well as the conductor and the control unit or multiple control units, positioning the single elements on the support element, connecting each single element, in particular the switch, operating elements, signaling elements or similar with the first end portions of the conductors and connecting the control unit with the corresponding other end portions of the conductors, conveying the support element with all the elements which are loaded thereon to a work station for attaching the end portions of the conductors to the control unit and optionally attaching the end portions of the conductors to the single elements, to thus realize a subassembly. In either a subsequent or parallel step, the structural component is prepared for receiving the subassembly by providing means for attachment as well as positioning the structural component and the subassembly relative to each other into an installation position.

Additionally, the method according to the present invention allows the automated assembly and attachment of a conductor assembly onto a structural component, such as a door paneling. The conductor assembly preferably comprises flexible circuit boards, so-called FPC (flexible printed circuits) as a replacement for the conventional circular conductors. Furthermore, the conductor assembly comprises various operating or signaling elements, such as switches and lighting, as well as at least one control unit, namely the door control device.

A special feature of this conductor assembly is the absence of any plug contacts because the switches and the door control device are soldered directly to the FPCs. By utilizing a support element which provides complete ease of access, to all elements of the conductor assembly, the soldering process can thus be carried out in a completely automated manner.

A significant advantage of the method according to the present invention is in the continuous automation of the conductor assembly and installation; that is, starting with the FPC production, which includes the integration of electronics, the direct contact between door control device and switches by means of a soldering process, for example a laser soldering process, up to installation of the conductor assembly into the door paneling is carried out in fully automated manner. While single steps of this method may be part of the prior art, however, no one has as yet found an arrangement of door paneling, door control device, switches and lights which when combined with suitable attachment techniques such as laser soldering, hot melt spray deposit, permits assembling and installation of the conductor assembly to be fully automated. (FPC+lights+door control device+switches).

Thus, one advantage of the present invention is the reduction in weight of the complete conductor assembly (FPC+lights+door control device+switches): One half of the door control device housing can be integrated into the door paneling, thereby realizing a 15% weight reduction. When integrating the lights in the form of LEDs onto the FPCs, a weight reduction of the lights by about 30% is realized.

By utilizing FPC instead of the conventional circular conductors, the weight of the conductor assembly is reduced by about 85%.

A further advantage in the method of the present invention is the overall volume reduction of the entire conductor assembly. By not utilizing plug contacts in addition to integrating the lights into FPC and the use of FPC instead of circular conductors, the volume of the conductor assembly can be considerably lowered. The round cable, at its thickest point has a dimension of 15×35 mm. The FPCs which have a thickness of only 0.2 mm accordingly require practically no room.

A further advantage of the present invention is the replacement of the plug contacts with direct contacts. Through the fully automated assembly and installation, the production of a plug-less conductor assembly is realized. This raises the system security and lowers cost considerably in a distinct way. Especially for large production volumes there is a definite cost reduction. A further advantage is the cost reduction, which can be realized from the fully automated assembly and installation, the integration of half of the control device housing into the door paneling, the absence of plug contacts and the integration of the lights into the FPC.

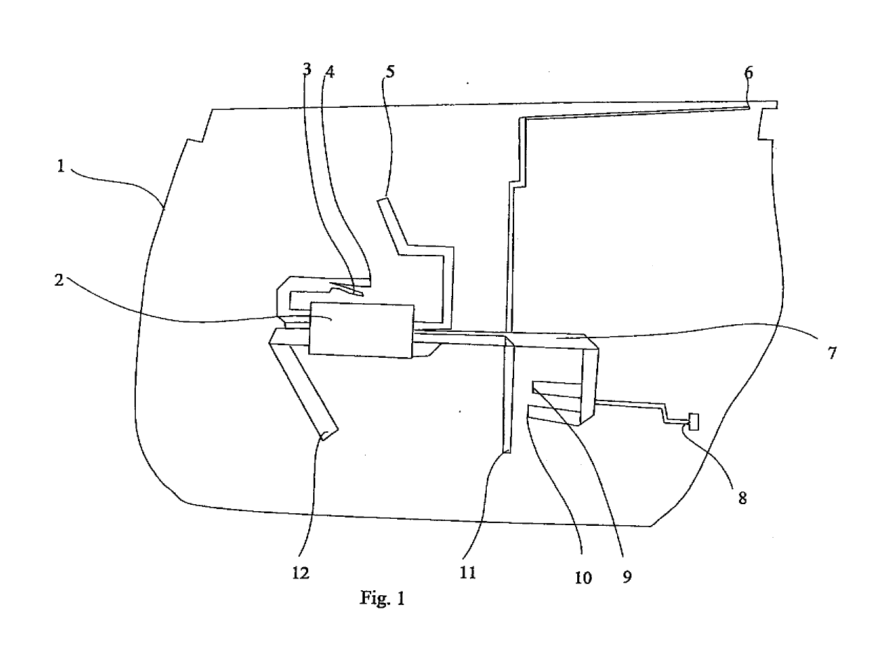

FIG. 1 shows a view of a structural component with built-in circuits and single elements;

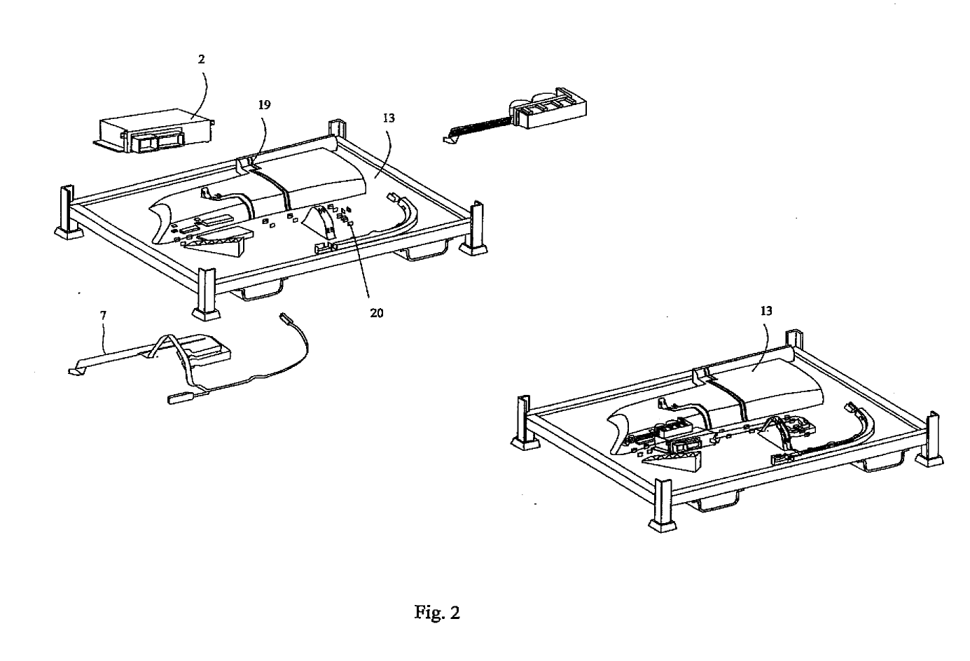

FIG. 2 shows the first steps of the assembly method;

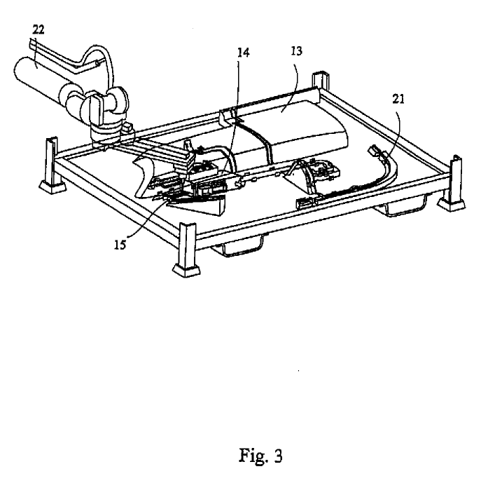

FIG. 3 shows the connection of the conductor end portions and control unit;

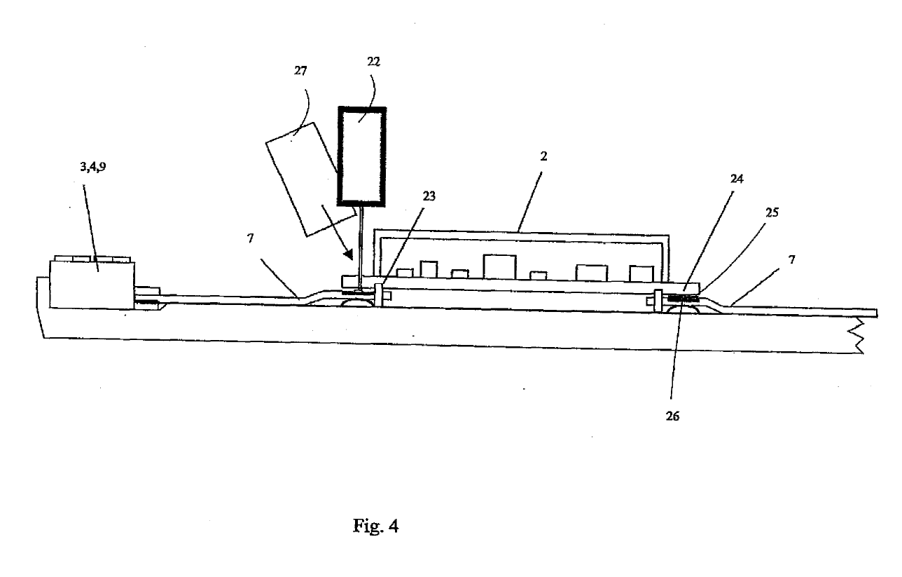

FIG. 4 shows the connection of conductor elements and control unit in detail;

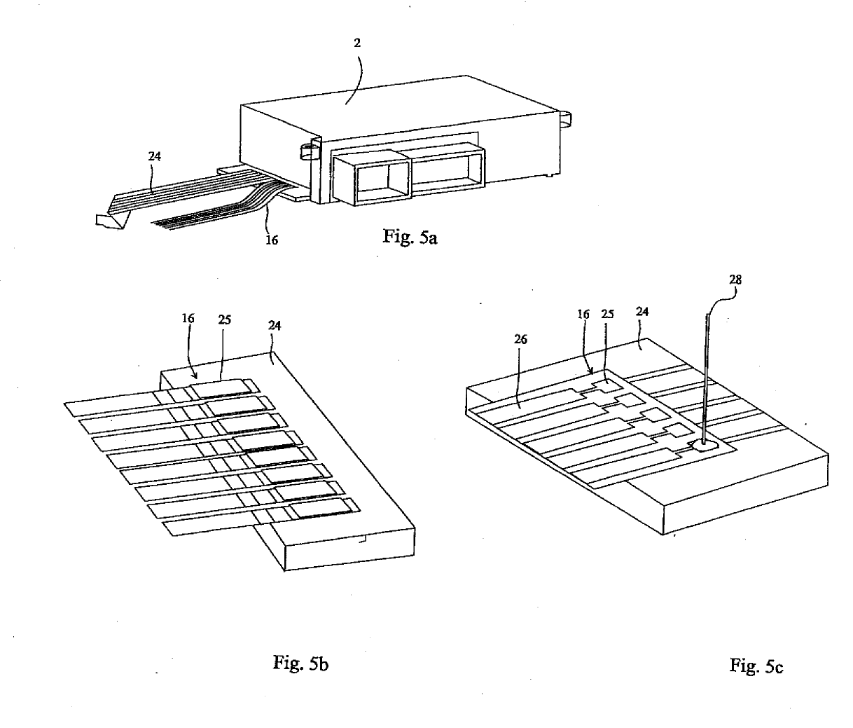

FIG. 5a shows the connection by means of a soldering process in detail;

FIG. 5b shows the soldering process according to a first embodiment;

FIG. 5c shows the soldering process according to a further embodiment;

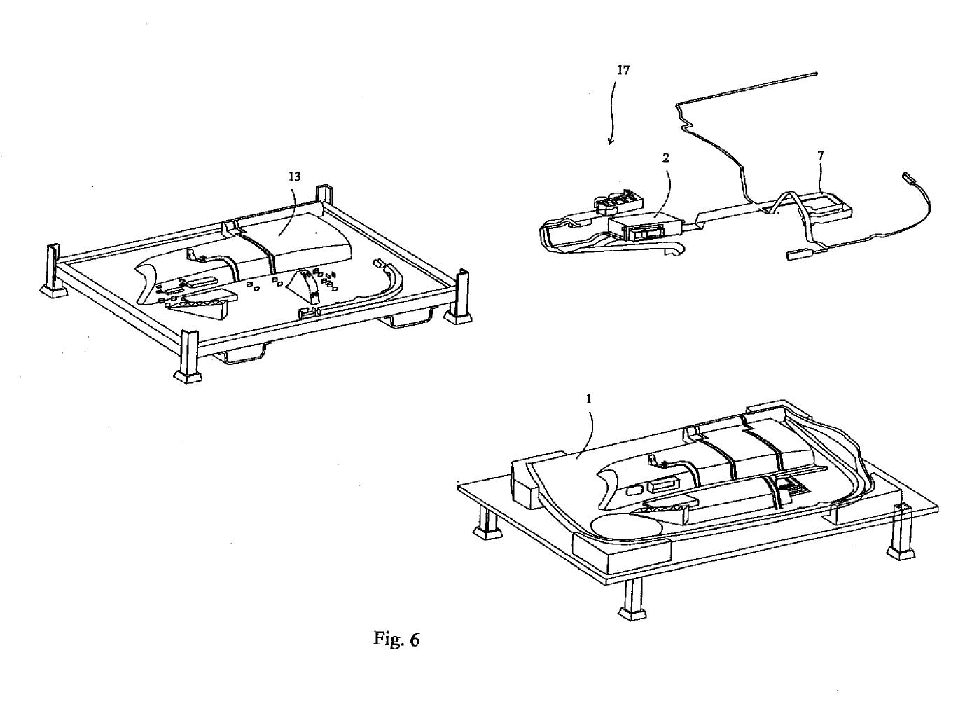

FIG. 6 shows the conductor set being taken from the support element and installed into a structural component;

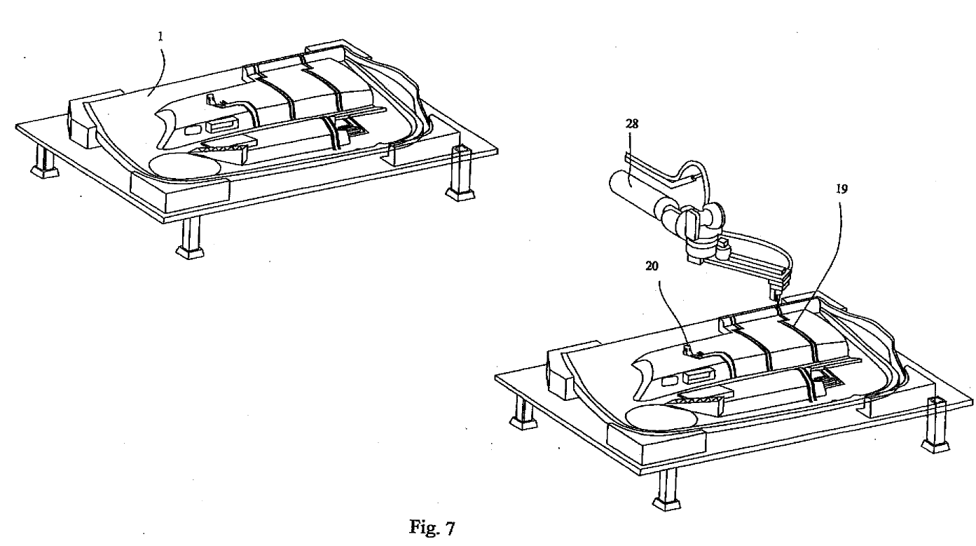

FIG. 7 shows the possibility of preparing the locations for positioning the subassembly 17 in the structural component 1 by means of an adhesive process;

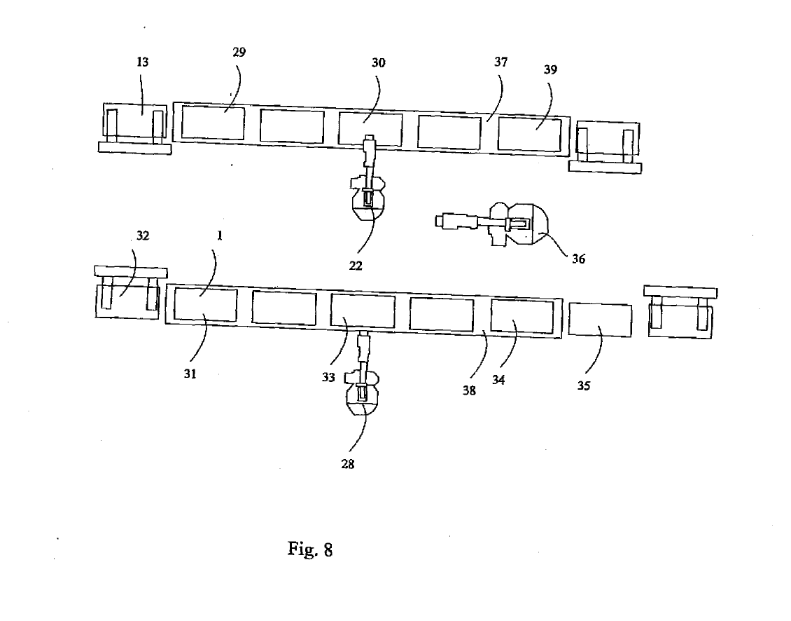

FIG. 8 shows a possible lay-out for the method.

FIG. 1 shows a structural component 1 and in this particular embodiment, a vehicle door with a subassembly 17 which comprises a number of conductor assemblies 21. Such conductor assemblies 21 each comprise at least one conductor 7, and a control unit 2 at one end and at least one operating element, switching element or signaling element at the opposite end. In this embodiment, the following switching elements are mentioned as examples, a switch 3 for positioning the rear view mirror, a switch 4 for the mechanism for opening and closing a window, a switch 9 for an anti-theft device, a switch 12 for positioning a vehicle seat, an operating element 10 for opening the trunk of a vehicle, as well as lighting elements or signaling elements such as door handle depression light 5, a vehicle entry light 11, a door warning light 8, a diode indicator for theft security.

FIG. 2 shows the first steps of the method for installing the subassembly 17. A support element 13 includes a plurality of channels 19 and projections 20, for the purpose of positioning single conductors, preassemblies of conductor assemblies with or without switching, operating, and signaling elements and positioning of single switching, operating, and signaling elements and control units 2. Within the context of the fully automated installation method, the positioning is carried out by means of one or several robots. Mass production of small batches or custom embodiments can also be supplemented with manual steps.

In FIG. 2, the conductor assemblies, switching, operating and signaling elements as well as the control unit that are separately shown in the left side illustration, are seen in the right hand side illustration installed on the support element 13. Since additional channels and projections are indicated on the support element 13 further elements can be installed on the support element 13.

FIG. 3 illustrates the soldering step by means of robot 22 of the first end portion of conductors 15 with the control unit 2. The second end portion of conductors 16 can optionally be soldered to single elements 14 as desired, if no plug contacts or similar are provided for the second end portion. This choice depends on the type of element to be installed.

FIG. 4 shows a soldering point in detail. The control unit 2 is connected to the support element 13 by means of at least one adjustment element, such as for example a pin. Conductor 7, which in this case is a foil conductor, is likewise positioned by the adjustment element 13. The conductor 7 is positioned between the support element 13 and the circuit board 24, which constitutes the connection area for the control unit 2. Fastened to the circuit board 24 are so-called connector pads which at their underside contain a solder depot. Thus, the assembly robot which carries out soldering needs to generate only the amount of energy necessary to solder the soldering point between the connector pad 25 and the conducting area 26 of the foil conductor. The soldering point is thus produced through supply of energy, for example via a laser. The connector pads 25 can be identified through a camera 27 fixed at the robot.

In FIG. 5a a variation of the laser soldering is shown, wherein the conductors 7 are positioned at the top side of the circuit board 24 of the control, unit 2.

FIG. 5b and FIG. 5c represent two alternative embodiments of the conducting areas of the end portions 16 of the conductors. FIG. 5b show the connector pads 25 which are positioned at the foil conductor. They can contain the solder depot.

FIG. 5c shows the connector pads 25 in which the solder depot is integrated into the foil conductor itself.

FIG. 6 shows the method steps of taking the subassembly 17 from the support element, the subassembly 17 and the positioning of the subassembly 17 into the structural component 1. In an intermediate station, the subassembly or the structural component can be prepared with an adhesive such as glue. Alternatively, the structural component can be provided with mechanical means for attachment, such as lug-connectors, snap-connectors or similar in order to hold the subassembly 17 in its place.

FIG. 7 shows the possibility to prepare those locations, which are designed for positioning the subassembly 17 in the structural component 1, by an adhesive process. A robot 28 supplies adhesive in the channels 19 or between the projections 20 in a line or in pointwise fashion.

FIG. 8 shows a possible arrangement of each of the method steps for the fully automated assembly and installation of a subassembly 17 into a structural component 1. In the loading station 29, conductors or conductor assemblies and switching, operating, lighting and signaling elements are positioned on the support element 13. The positioning can be carried out by robot or manually and is not shown here in detail. After so loading the support element 13, it moves onwards on a conveyor belt 37 into the soldering station 30. In the soldering station 30, all soldering connections are made by a robot 22. After termination of the soldering steps, removal of the subassemblies 17 from the support element 13 follows through robot 36.

The robot is preferably provided with gripper elements, which are operated by means of a vacuum. Also, a gripper element can be configured so as to be adapted to the form of the subassembly such that positioning of each element onto the structural component 1 can be realized in a secure and precise manner.

In parallel method steps, the structural component 1 is being prepared. In a further loading station 31, the structural component 1 is positioned at a support frame 32. In the subsequent adhesive station 33, adhesive is applied at those locations of the structural component where the conductor assembly is to be installed. The conveyor belt 38 continues to move to the installation station 34. As soon as the structural component has reached the support frame of the installation station 34, the robot 36 picks up the subassembly 17 from the support element 13 and positions it in the structural component 1. In a subsequent method step the structural component 1 is removed in the pick-up station 35.

### LIST OF REFERENCE NUMERALS

1. structural component, door
2. control unit, door control device
3. switch mirror position setting
4. switch window lifter
5. door handle depression lighting
6. diode indicator-anti-theft device
7. ribbon cable conductor
8. door warning light (diode light)
9. switch anti-theft
10. car trunk opener
11. car entry light (diode-access light)
12. seat memory switch
13. support element
14. single element
15. end portion of the conductor
16. end portion of the conductor
17. subassembly
18. attachment means
19. channel
20. projection
21. conductor assembly
22. robot
23. adjustment element
24. printed circuit board
25. connector pad
26. conducting area
27. camera
28. robot
29. loading station
30. solder station
31. loading station structural component
32. support frame
33. adhesive station
34. installation station
35. pick-up station
36. robot
37. conveyer belt
38. conveyor belt
39. removal station

1. Method for connecting several switches, operating elements, signaling elements or similar, to be supplied with electric energy, with a control unit mounted by automated means onto a structural component (1), in particular, a vehicle door, wherein electric energy is transmitted through conductors (7) in particular, flexible circuit boards comprising a plurality of signaling conductors, which are arranged on a substantially flat ribbon, on which several conductors are arranged independently of each other, each of which capable of branching out into a single element (14) such as a switch, operating element or signaling element (3, 4, 5, 6, 8, 9, 10, 11, 12) and wherein the other ends of the conductors (7) are connected to a control unit (2), characterized by the following steps: preparing a support element (13) for receiving all single elements (14), such as the switch, operating elements, signaling elements or similar conductors, and the control unit, collectively representing the conductor assembly; positioning the single elements (14) on the support element (13), connecting the single elements (14) in particular, the switch, operating elements, signaling elements or similar with the first end portions of the conductors (15) and connecting the control unit with the corresponding other end portions of the conductor (16); conveying the support element (13) with all load elements (17) to a subsequent treatment station for fastening the end portions of the conductors (16) to the control unit (2) and optionally fastening the end portions of conductor (15) to the single elements (14), thereby forming the subassembly (17); preparing the structural component (1) for installation of the subassembly (17) through attachment means (18), and positioning the structural component (1) and the subassembly (17) relative to each other into their installing location.

2. Method according to claim 1, characterized in that the support element (13) has a three-dimensional configuration, which mirrors the position of all elements in their location at the structural component.

3. Method according to claim 1, characterized in that the end portions of conductors (15, 16) are attached by means of a soldering process.

4. Method according to claim 1, characterized in that the soldering process is a laser soldering process.

5. Method according to claim 1, characterized in that the positioning of the structural component (1) is carried out through placement of the structural component (1) onto the subassembly (17).

6. Method according to claim 1, characterized in that the positioning of the structural component (1) and the subassembly (17) is carded out through positioning the subassembly (17).

7. Method according to claim 1, characterized in that the subassembly (17) is positioned onto the structural component (1) by means of a gripper device.

8. Method according to claim 6, characterized in that during the positioning steps, attachment means (18) are engaged.

9. Method according to claim 1, characterized in that the attachment means (18) are screws, rivets, adhesives, clamps and similar.

10. Method according to claim 1, characterized in that positioning aids are provided at the support element (13).

11. Method according to claim 1, characterized in that the positioning aids are channels (19).

12. Method according to claim 1, characterized in that the positioning aids are projections (20).

13. Method according to claim 7, characterized in that during the positioning steps, attachment means (18) are engaged.
